(19) United States
(12) Patent Application Publication
(10) Pub. No.: US 2009/0132169 A1
(43) Pub. Date: May 21, 2009

(54) METHODS AND SYSTEMS FOR EVALUATING FLUID MOVEMENT RELATED RESERVOIR PROPERTIES VIA CORRELATION OF LOW-FREQUENCY PART OF SEISMIC DATA WITH BOREHOLE MEASUREMENTS

(75) Inventor: Georgiy Bordakov, Richmond, TX (US)

Correspondence Address: SCHLUMBERGER OILFIELD SERVICES, 200 GILLINGHAM LANE, MD 200-9, SUGAR LAND, TX, 77478, US

(73) Assignee: Schlumberger Technology Corporation, Sugar Land, TX (US)

(21) Appl. No.: 11/942,031

(22) Filed: Nov. 19, 2007

(51) Int. Cl. G01V 1/40; G01V 1/28

(52) U.S. Cl. 702/11; 367/35; 702/14

(57) ABSTRACT

A method for identifying a nature of formation contrasts that cause changes in seismic or sonic wave properties in a low-frequency range includes obtaining a selected property of a formation surrounding a borehole, wherein the selected property is at least one selected from the group consisting of a permeability and a fracture density; decomposing seismic signals into a set of instant amplitudes and frequency fields; calculating a plurality of low-frequency attributes characterizing the low-frequency range of the seismic signals; and establishing a correlation between at least one of the plurality of the low-frequency attributes and the selected property of the formation.

### BACKGROUND OF INVENTION

1. Field of Invention

This invention relates to methods and systems for determining formation properties based on low-frequency seismic data and other well logging data.

2. Background Art

In hydrocarbon exploration and production, it is important to determine whether an earth formation contains hydrocarbon and how much hydrocarbon is in the formation. Underground hydrocarbons, as well as water, are typically contained in pore space in the formations. Seismic tools are commonly used to determine the geophysical structures of earth formations because of their unique abilities to detect boundaries of various subsurface structures.

When seismic energy excites a reservoir, the pore fluids, being more compressible than the surrounding solid matrix, would react differently as compared to the solid matrix. As a result, there is relative movement of the pore fluids with respect to the solid matrix. This relative movement would cause a loss of some energy of the waves. This relative movement is insignificant in typical porous formations of low or medium permeability, rendering it very difficult to detect such effects. The relative movement (and hence the energy loss) may be significant when there are fractures in the formation or permeability of the formation is relatively high. Because fractures often contain hydrocarbons, identification of the fractures is important in oil and gas exploration. Identification of permeable formations is also important since it is a major factor determining the ability to recover the hydrocarbons.

The loss of energy in the seismic or acoustic waves varies with the frequencies of the waves, with more effects seen at low frequency ranges. Thus, analysis of such low-frequency effects in the seismic or acoustic data may provide insights into the permeability or fractures of a formation.

Prior art methods related to low-frequency seismic attributes correlation with permeability and fractures, for example, are disclosed in G. A. Bordakov, E. Yu. Mikolaevski, S. Ya. Sekerzh-Zenkovich, “On Evaluation of the Rock Permeability and Porosity through Seismic Spectral Analysis,” 59th Annual EAGE Conference & Exhibition, 26-30 May 1997, Geneva, Switzerland, Expanded Abstracts Book, F014 and U.S. Pat. No. 7,136,757, which is issued to Goloshubin et al. This patent discloses a method for identifying, imaging and monitoring dry or fluid-saturated underground reservoirs using seismic waves reflected from target porous or fractured layers. Seismic imaging of the porous or fractured layer occurs by low pass filtering of the windowed reflections from the target porous or fractured layers, leaving frequencies below the lower-most corner (or full width at half maximum) out of a recorded frequency spectra. Additionally, the ratio of image amplitudes is shown to be approximately proportional to reservoir permeability, viscosity of fluid, and the fluid saturation of the porous or fractured layers.

Because information about formation permeability and fracture density is important for oil and gas exploration, there is a need for methods that can be used to assess permeability and/or fracture density of the formations.

### SUMMARY OF INVENTION

One aspect of the invention relates to methods for identifying a nature of formation contrasts that cause changes in seismic or sonic wave properties in a low-frequency range. A method in accordance with one embodiment of the invention includes obtaining a selected property of a formation surrounding a borehole, wherein the selected property is at least one selected from the group consisting of a permeability and a fracture density; decomposing seismic signals into a set of instant amplitudes and frequency fields; calculating a plurality of low-frequency attributes characterizing the low-frequency range of the seismic signals; and establishing a correlation between at least one of the plurality of the low-frequency attributes and the selected property of the formation.

Another aspect of the invention relates to systems having a processor and a memory, wherein the memory stores a program having instructions for causing the processor to perform a method for identifying a nature of formation contrasts that cause changes in seismic or sonic wave properties in a low-frequency range, the method includes obtaining a selected property of a formation surrounding a borehole, wherein the selected property is at least one selected from the group consisting of a permeability and a fracture density; decomposing seismic signals into a set of instant amplitudes and frequency fields; calculating a plurality of low-frequency attributes characterizing the low-frequency range of the seismic signals; and establishing a correlation between at least one of the plurality of the low-frequency attributes and the selected property of the formation.

Another aspect of the invention relates to methods for enhancing poro-elastic effects in a seismic signal spectrum, F(ω). A method in accordance with one embodiment of the invention includes finding a derivative of the seismic signal spectrum, dF(ω)/dω; and performing an estimation of an integral of a function of dF(ω)/dω in a clockwise circular path in a complex plane centered at the coordinate origin, wherein the integration is performed starting and finishing at the same frequency, ω.

Other aspects and advantages of the invention will be apparent from the following description and the appended claims.

### BRIEF DESCRIPTION OF DRAWINGS

FIG. 1 shows a flow chart, illustrating a work flow in accordance with one embodiment of the invention.

FIG. 2 shows a flow chart, illustrating methods of obtaining borehole permeability and fracture density in accordance with one embodiment of the invention.

FIG. 3 shows a flow chart, illustrating a process for picking a reference area of the seismic signals in accordance with one embodiment of the invention.

FIG. 4 shows a flow chart, illustrating a method for propagating the correlation from the borehole into a 3D space surrounding the borehole in accordance with one embodiment of the invention.

FIG. 5 shows a chart illustrating integration in the complex space.

FIG. 6 shows a diagram of a conventional computer system that may be used with embodiments of the invention.

### DETAILED DESCRIPTION

Embodiments of the invention relate to methods and systems for determining formation properties based on low-frequency seismic or acoustic attributes that arise from relative movement of pore fluids with respect to the solid matrix. While embodiments of the invention may be applied to seismic and/or acoustic measurements, for clarity of illustration, “seismic” may be used in a general sense to include both seismic and acoustic. In accordance with embodiments of the invention, the low-frequency seismic attributes can provide information about a selected formation property, such as formation permeability, formation fracture densities, etc.

As noted above, seismic or acoustic excitation of pore fluids may induce relative movement of the pore fluids relative to the solid matrix of the rock. This relative movement results in loss of some seismic wave energy and gives “new dimension” to elastic wave phenomena. This relative movement produces specific types of waves, which are slow compressional waves.

Because the movement of the pore fluids relative to the solid matrix is extremely small in typical formation pores, the resultant slow compressional waves are very difficult to observe. Consequently, the general conclusion in the literature is that these effects are insignificant. However, based on theoretical conclusions and field observations, the inventor of the present invention and others have shown that these effects may be significant when significant lateral and/or vertical fluid mobility contrasts exist (see for example, G. A. Bordakov, E. Yu. Mikolaevski, S. Ya. Sekerzh-Zenkovich, “On Evaluation of the Rock Permeability and Porosity through Seismic Spectral Analysis,” 59th Annual EAGE Conference & Exhibition, 26-30 May 1997, Geneva, Switzerland, Expanded Abstracts Book, F014; G. Goloshubin, C. Van Schuyver, V. Korneev, D. Silin, V. Vingalov, “Reservoir Imaging using low frequencies of seismic refections,” The Leading Edge, May 2006, p. 527). These fluid mobility contrasts can result from natural and induced fractures, diagenetic changes in carbonates, changes of rock properties during hydrocarbon production, or gas/oil/water contacts, to name a few. Although the nature of these contrasts may not be readily discernable from the seismic or acoustic data alone, the nature of these contrasts can be identified and characterized using cores, well logs, borehole image and well test data.

Even though the slow compressional waves resulting from the fluid mobility contrasts may be difficult to detect directly, they may have influence on the amplitudes and spectral compositions of the waves that are conventionally observed in seismic and borehole acoustic measurements, e.g. compressional and Stoneley waves. Therefore, it may be possible to detect these slow compressional waves indirectly, i.e., by analyzing their impact on the compressional or Stoneley waves. Embodiments of the invention provide methods for formation characterization using information derived from these difficult to detect waves. Specifically, methods in accordance with embodiments of the invention combine the low-frequency seismic (or acoustic) attributes with other data to characterize the formations.

Poro-elastic properties of the rocks can produce significant effects on seismic and acoustic measurements. Based on a variety of theoretical models, a reflection coefficient of the boundary between solid and permeable rock for normally incident compressional wave can be represented as:

|R(f)|=|R(0)|(1−β\sqrt{f/f_{c}}+O(f/f_{c})) (1)

where f is the frequency of the wave, R(0) is the reflection coefficient of purely elastic interactions, f_{c} is a characteristic frequency that is inversely proportional to the fluid mobility, and the coefficient β is greater than zero (i.e., β>0) and does not depend on the impedance contrast between rocks.

The square root term in equation (1) is characteristic of poro-elasticity and usually cannot be explained by elastic or visco-elastic models. Embodiments of the invention make use of the seismic or acoustic attributes that arises from this poro-elastic property to characterize formation permeability and/or fracture density. Some embodiments of the invention provide methods for enhancing the extraction of seismic/acoustic attributes due to poro-elasticity from seismic or acoustic data, by applying a suitable filter (e.g., a square root filter) to the seismic or acoustic data. These filtering methods will be described in detail later.

The value of f_{c} is typically in the range of 1-10 kHz. The square root term in the above equation could be significant in the seismic frequency range of 10-50 Hz. This effect manifests itself as relative enrichment of the low-frequency part of the seismic signals. As a result, attributes corresponding to portions of the relative low-frequency signals or derivatives of spectrum amplitudes with respect to frequencies can provide good correlations with fluid permeabilities. Furthermore, similar attributes derived from amplitude versus offsets (AVO) gathers may provide even more significant results because these effects increase with the angles of reflections.

Effects due to fluid movement relative to the matrix are most significant around the characteristic frequency f_{c}. This frequency is within the typical operational range of a variety of seismic or sonic logging tools (e.g., SonicScanner® from Schlumberger Technology Corp., Houston, Tex.).

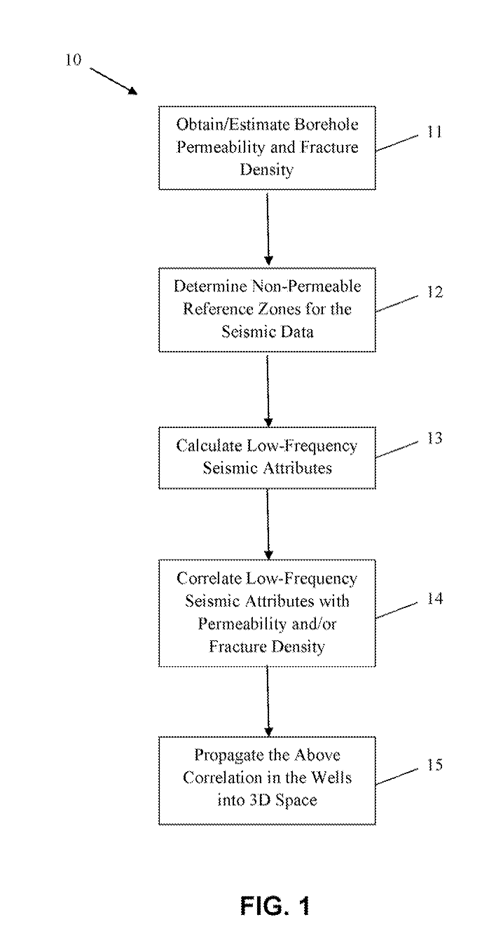

In accordance with one embodiment of the invention, FIG. 1 shows a flow chart illustrating a workflow, which may be implemented using existing and/or newly developed software applications. As shown in FIG. 1, a method 10 may start with obtaining or estimating borehole permeability or fracture density of the formations (step 11). These permeability or fracture density may be obtained from prior calculations. Alternatively, these permeability or fracture density data may be computed/estimated from borehole logging data, including seismic data, well test data, resistivity data, etc.

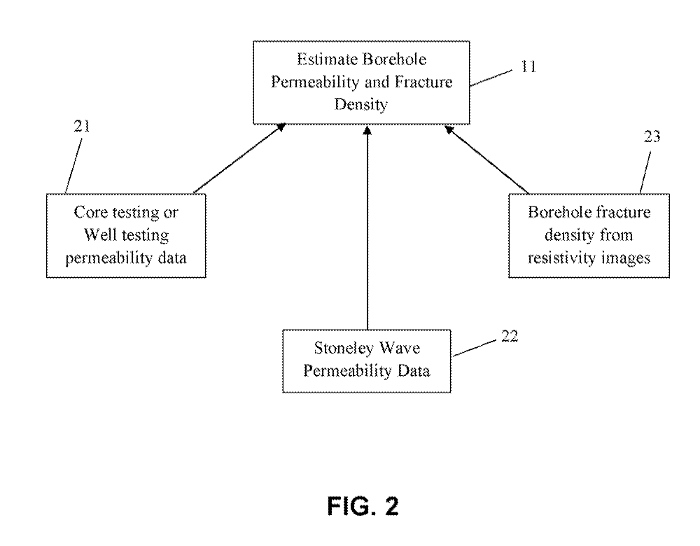

For example, borehole permeability may be estimated from Stoneley waves using any suitable application or program—an existing application or a new application such as that proposed in WO 2007/001746. In such estimation, the velocity and attenuation data may be obtained from a suitable model. The velocity and attenuation data, as well as the Stoneley wave permeability data, may be stored. In accordance with some embodiments of the invention, data showing azimuthal and radial variation (such as those obtained with SonicScanner®) are preferably used. Methods of obtaining or estimating permeability and/or fracture density will be discussed in more detail with reference to FIG. 2.

Borehole permeability and fracture density data, once available, may be stored, for example, in a computation package such as Petrel®. In this process, core and well test permeability values, if available, may also be stored.

Next, the method 10 may determine one or more non-permeable reference zones for the seismic data (step 12) and calculate the low-frequency seismic attributes from the low-frequency portion of the seismic data (step 13), which will be described in more detail later. As noted above, the square root term in equation (1) is unique to poro-elasticity. The seismic data used for the derivation of the low-frequency seismic attributes may be the original data or data that have been enhanced by proper filtering to emphasize the poro-elastic information. The process of such enhancement by filtering will be described later.

The low-frequency seismic attributes are then correlated with a selected formation property (e.g., permeability and/or fracture density) (step 14). Using permeability (derived from Stoneley waves or obtained from core analysis or from well tests) or fracture density, one can build correlation between the permeability (or fracture density) and surface seismic attributes (i.e., low-frequency seismic attributes around the borehole). This correlation may employ least square fit or any suitable method.

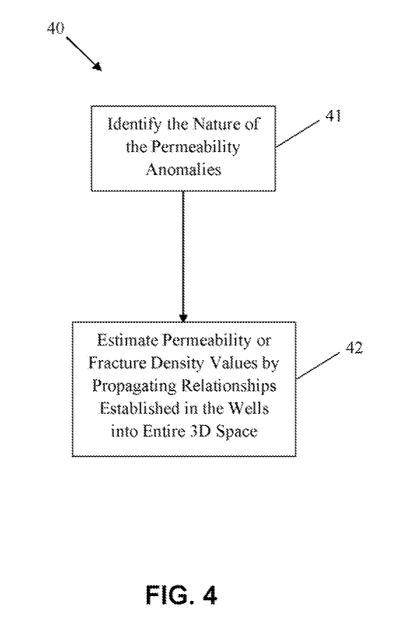

Provided reasonable correlation is found, permeability and/or fracture density may be geo-statistically distributed from the boreholes to the whole reservoir (3D space) using best fit attribute or attributes (step 15). This propagation allows one to estimate the permeabilities and/or fracture densities between wells. An example of such propagation is illustrated in FIG. 4. In this manner, regression of the borehole properties based on the low-frequency seismic attributes can be used to characterize the reservoirs (which may be away from the well bore).

Referring to FIG. 2, borehole permeability needed for the correlation may be derived from many sources, including core testing or well testing data (shown as 21) or Stoneley wave data (shown as 22). A number of Stoneley-wave permeability methods are known in the art. For example, U.S. Pat. No. 4,797,859 issued to Hornby discloses a method for determining the permeability using Stoneley-wave slowness (reciprocal of velocity). In accordance with this method, the slowness of a hypothetical Stoneley wave traveling in an elastic, non-permeable medium was computed based on an elastic borehole model. Then, the computed Stoneley-wave slowness was subtracted from the measured Stoneley-wave slowness. The difference was used to determine formation permeability.

U.S. Pat. No. 4,964,101 to Liu et al. discloses a similar method. The difference is that the inversion model includes a mud cake compensated parameter to correct for the measured Stoneley-wave slowness. The compensated parameter has an equivalent effect on Stoneley-wave slowness as permeability.

Tang et al., “Dynamic permeability and borehole Stoneley waves: A simplified Biot-Rosenbaum model,” J. Acoust. Soc. Am. 90, 1632-1646 (1989), developed a method using Stoneley-wave central time shift and the corresponding wave central frequency shift to determine formation permeability. Generally, an attenuation of 1/Qsτ will cause a shift of wave central frequency down to lower frequency. Such a central frequency shift is due to the total attenuation, which is not uniquely related to the attenuation due to formation permeability. The attenuation (1/Qsτ) due to formation permeability is independent of the propagation distance, while the central frequency shift is propagation distance dependent.

Methods for direct determination of permeability using Stoneley-wave attenuation (1/Qsτ) are known. For example, Cassell, et. al., “Permeability prediction based on anelastic attenuation using dipole and low frequency monopole sources in a Carbonate Reservoir in Saudi Arabia,” presented at the CEO-94 Middle East Geoscience Exhibition & Conference, Bahrain, Apr. 25-27, 1994, presents a method of using Stoneley-wave attenuation to predict formation permeability for a carbonate formation based on an empirical relationship between Stoneley-wave attenuation and permeability. U.S. Pat. No. 6,327,538 issued to Chin developed a method using the total waveform energy (attenuation-related) to predict permeability based on an empirical relationship between waveform energy and permeability. Tang and Cheng, “Quantitative borehole acoustic methods,” Elsevier (1996), developed a method that uses Stoneley-wave amplitude to predict permeability based on a simplified Biot-Rosenbaum model.

Recently, a method for permeability determination from acoustic Stoneley wave measurements is presented in WO 2007/001746, which discloses a method for directly using frequency-dependent Stoneley-wave attenuation 1/Qsτ with full Biot theory, instead of simplified versions of the theory, to determine permeability. Biot theory describes seismic wave propagation in porous media consisting of solid skeleton and pore fluid (gas, oil, or water) and allows geophysicists to directly relate the seismic wave field to formation permeability.

Furthermore, Goloshubin et al. (G. Goloshubin, D. Silin, “Frequency dependent seismic reflection from a permeable boundary in a fractured reservoir,” SEG 2006 Annual Meeting Expanded Abstracts, v. 25, p. 1742; G. Goloshubin, C. Van Schuyver, V. Korneev, D. Silin, V. Vingalov, “Reservoir Imaging using low frequencies of seismic refections,” The Leading Edge, May 2006, p. 527) proposes a new poro-elastic model, in which the described effects are amplified with each fluid mobility change along the trajectory of the wave. This model considers thin channels between vuggy pores as the main source of the fluid movement. Compared to the classic model of Biot, such an approach may be more applicable to naturally fractured or carbonate rocks. This model (i.e., equations derived from this model) for Stoneley wave analysis (instead of Biot's, as it is typically done) may provide improvement to Stoneley wave permeability application. Similarly, a Briot-Barenblatt model, which is a combination of Biot's poroelasticity and Barenblatt's. dual medium models, may also be used. See, G. Goloshubin, D. Silin, “Frequency dependent seismic reflection from a permeable boundary in a fractured reservoir,” SEG 2006 Annual Meeting Expanded Abstracts, v. 25, p. 1742.

In accordance with embodiments of the invention, Stoneley wave permeability may be determined using any suitable applications, including existing applications or new applications. An example of a new application is disclosed in WO 2007/001746, with Stoneley wave attenuation determined by the theory proposed in G. Goloshubin, and D. Silin, “Frequency dependent seismic reflection from a permeable boundary in a fractured reservoir,” SEG 2006 Annual Meeting Expanded Abstracts, v. 25, p. 1742. In accordance with some embodiments of the invention, the data showing azimuthal and radial variation (such as data from SonicScanner®) are used preferably.

In addition to permeability, embodiments of the invention may also correlate the low-frequency seismic attributes with fracture density of a formation (shown as 23 in FIG. 2). In fractured reservoirs, effective fluid mobilities in the seismic wavelength range may be mostly influenced by fracture permeabilities rather than by matrix permeabilities. However, ultrasonic, core, and even well test data will mostly reflect matrix permeabilities. In comparison, resistivity measurements are more suitable for identifying fractures. Therefore, fracture densities may be better evaluated from borehole images, which are typically mapped with resistivity tools. To derive fracture density from borehole images, any suitable program/application, such as the modified FracView® (from Schlumberger Technology Corp.), may be used. Once the fracture densities are available, they can be correlated with the surface seismic attributes (e.g., step 14 in FIG. 1), and estimation of the fracture densities between wells in turn can then be built (e.g., step 15 in FIG. 1).

Surface seismic attributes noted above are the attributes that amplify the above-described square root of frequency dependence of the reflection coefficient when permeable rock is present. Any of such attributes may be used with embodiments of the invention. With the reflection coefficient R(f), variables such as d_{5qrt}=\sqrt{f} ∂|R(f)|/∂f, tangent (τ) of the value ln(∂|R(f)|/∂f) with regard to f, or d_{τ}=f^{-τ} ∂|R(f)|/∂f can be estimated and averaged in the low frequency part of the seismic spectrum. However, two issues arise: (1) one cannot observe R(f) directly (only the product of R(f) and the spectrum of seismic source signal); and (2) it is not clear how the low-frequency part of a seismic spectrum should be defined. In accordance with embodiments of the invention, an alternative to R(f) is used and one or more methods of defining the low-frequency range are proposed.

In accordance with some embodiments of the invention, the values of the variables d_{sqrt}, τ, d₉₆ , are determined based on S(f)/S₀(f), instead of R(f). S(f) is the spectrum of the seismic data in the area of interest, and S₀(f) is the averaged spectrum in the reference area, where fluid mobility effects are absent. Methods for the determination of the reference areas will be discussed later.

In accordance with one embodiment of the invention, low-frequency ranges can be determined with reference to S₀(f), for example, as a range between a low percentile (e.g. 10% or some other number selected by a user) and the median of the reference S₀(f). Alternatively, one can also determine the values of d_{sqrt}, τ, d_{τ} from S(f) without the reference S₀(f). In this case, the low frequency ranges may be determined based on S(f).

Referring to step 12 in FIG. 1, in accordance with embodiments of the invention, one can determine a reference area using the instant frequencies of seismic waves from Hilbert transform by picking contiguous zones with frequencies around the median or by using principal component analysis of the seismic signals. The component analysis may be performed in the following manner.

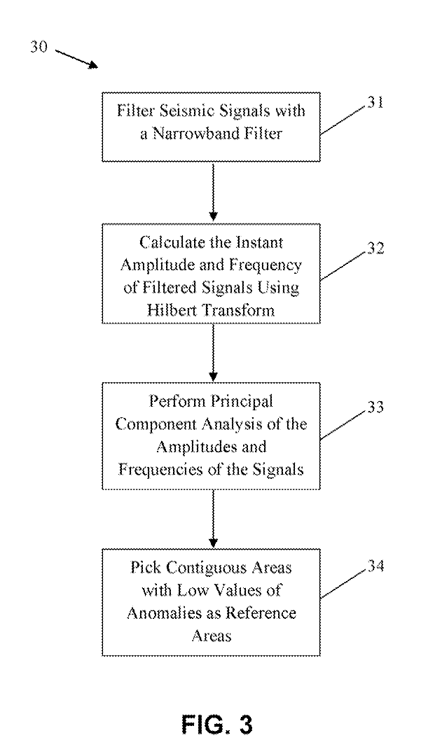

Referring to FIG. 3, in accordance with a method 30, all seismic traces may be first filtered with a brush of narrow filters (e.g., narrow triangular filters with frequency increment of 0.05-0.1 of dominant frequency) to decompose the signals (step 31). Then, for each filtered signal, its instant amplitude and frequency are calculated with Hilbert transform (step 32). Afterwards, the principal component analysis is performed for the amplitudes and frequencies of the filtered signals in the areas that include areas of interest and areas without movable fluids (step 33).

The principal component with the greatest eigenvalue should represent seismic source spectrum. Other components having eigenvalues up to some cutoff (for example, 95% of the greatest eigenvalue) can represent anomalies of interest. Contiguous areas with low values of anomalies may be picked as reference (step 34). In accordance with alternative embodiments, this analysis may be performed on seismic AVO gathers.

In accordance with one embodiment of the invention, the low-frequency seismic attributes may be calculated as follows. First, one may perform fitting of the actual trace spectra S(f), taken in a sliding window along the trace, to the model spectra in the form of a series of the square root of frequency,

$$W ( f ) {\sum }_{i = 0}^{K} {{a}_{i} ( \sqrt{f} )}^{i} ,$$

wherein K=a small integer (preferably 1≦K≦5; more preferably K=2), W(f) represents the spectrum of the incident wave, S₀(f), and aᵢ are complex coefficients determined by fitting the actual and model spectra using least square fit or any suitable model. Note that any seismic wavelet known in the art or wavelet obtained by seismic deconvolution procedure known in the art may be used as W(f).

Next, one calculates the absolute values of the ratios of

$$\vert \frac{{a}_{i}}{{a}_{0}} \vert ,$$

wherein 1≦i≦2 (assuming K=2 in the above series of square root of frequency, generally 1≦i≦K), wherein a₀ and aᵢ are determined by the spectra fitting in a sliding window along the trace described above. These ratios

$$\vert \frac{{a}_{1}}{{a}_{0}} \vert$$

constitute attributes of spectral decomposition over square roots of frequency and can be used as indicators of the poro-elasticity of the formations. In accordance with alternative embodiments, this analysis may be performed on seismic AVO gathers.

The body of attributes, such as d_{sqrt}, τ, d_{τ}, picked with or without a reference, instant frequencies, principal component representing anomalies, attributes of spectral decomposition over square roots of frequency calculated with seismic common depth point (COP) gathers, amplitude versus offset (AVO) gathers or other types of gathers with common reflection points and reflection angles are referred later as “low-frequency seismic attributes” in this description.

Once these low-frequency seismic attributes are calculated, embodiments of the invention may be used to correlate these low-frequency seismic attributes with the permeabilities derived from core, well tests, and/or ultrasonic data and/or with fracture density (see step 14 in FIG. 1). In accordance with some embodiments of the invention, these low-frequency seismic attributes can be correlated with permeabilities and/or fracture densities, individually or in combination. Furthermore, the best combination may be determined using regression analysis. In addition, some embodiments of the invention provide methods for propagating the discovered dependencies (correlation) between wells using geo-statistical methods (step 15 in FIG. 1).

For correlation and propagation, one may use any software known in the art, such as Petrel®. Low-frequency seismic attributes calculation and their regression analysis with reservoir properties of interest may be implemented as an independent package or as a plug-in of an existing program (e.g., Petrel®).

The above-described methods provide a set of computer applications and a workflow to evaluate fluid mobility and fracture density via correlation of low-frequency parts of seismic data with ultrasonic and/or electromagnetic borehole measurements (e.g., permeabilities or fracture densities). Furthermore, some embodiments of the invention relate to methods for propagating the relationship between the low-frequency seismic attributes and borehole permeability (and/or fracture density) into the reservoirs (3D space). FIG. 4 illustrates a method that uses a 3D distribution of low-frequency seismic information to map permeability anomalies, including those related to fractures and diagenetic effects.

As shown in FIG. 4, a method 40 includes: (1) identifying the nature of the permeability anomalies including those related to fractures and diagenetic effects (step 41), which may be performed as described above; and. (2) estimating permeability or fracture density values by propagating relationships established in the wells into entire 3D space (step 42). The propagating (step 42) may use geo-statistical multivariate distribution of the permeability or fracture density based on best correlated attributes that characterize the low-frequency range of seismic signals or their combinations. Any geo-statistical multivariate techniques may be used, such as co-kriging, which is an interpolation technique that can produce better estimate map values, when the distribution of a secondary van ate sampled more intensely than the primary variate is known.

As noted above, one characteristic feature of the elastic wave reflection/refraction from the boundary of the poro-elastic rock is the presence of square root of frequency terms in the reflection/refraction coefficient (see equation (1)). This is characteristic to poro-elasticity and usually cannot be explained by elastic and visco-elastic models. Some embodiments of the invention relate to methods for enhancing the poro-elastic signals in conventional seismic or acoustic data. These methods use selected filters to enhance the contribution of signals corresponding to the square root term shown in equation (1). The filters used in these methods will be referred to as “square root filters” because they enhance the contribution of the poro-elastic signals reflected in the square-root term in equation (1). The following describes the theory and procedures for the square root filtering.

If ω is the circular frequency, one can expect reflection and/or refraction coefficients of a medium containing poro-elastic layers to have a general form: R(ω)=R₁(ω)+\sqrt{ω}R₂(ω). Here, R₁, R₂ are analytic functions, which may be sums of converging Taylor series. With analytic input signals from a Fourier spectrum S(ω), one can expect the reflected/refracted signal spectrum to have the form: F(ω)=F₁(ω)+\sqrt{ω}F₂(ω). By separating \sqrt{ω}F₂(ω), one can better evaluate the influence of poro-elasticity.

If the derivative of the spectrum,

$$\frac{d F ( ω )}{d ω} ,$$

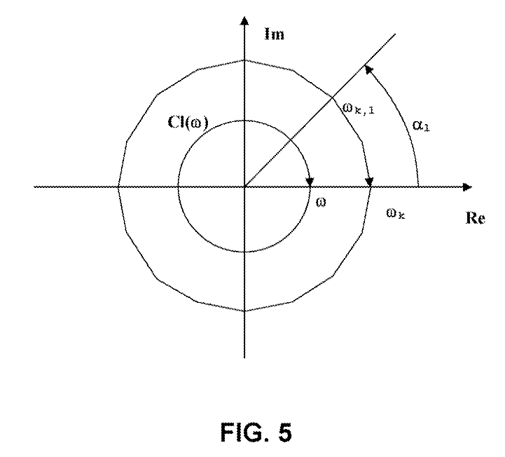

in the space of complex ω is known, then the integral

$$G ( ω ) = {∮}_{Cl ( ω )} \frac{1}{2} \frac{d F ( ϛ )}{d ϛ} d ϛ ,$$

wherein Cl(ω) is the clockwise circular path in the complex plane centered at the coordinate origin and starting/finishing at ω (see FIG. 5), will be equal to:

$$G ( ω ) = \frac{1}{2} \{ ( {F}_{1} ( ω ) + \sqrt{ω} {F}_{2} ( ω ) ) - ( {F}_{1} ( ω ) + {e}^{jπ} \sqrt{ω} {F}_{2} ( ω ) ) \} = \sqrt{ω} {F}_{2} ( ω )$$

(here j is an imaginary unit). Thus, G(ω) gives an estimation of poro-elasticity related part of the signals in the Fourier spectrum. Similarly, the inverse Fourier transform \tilde{G}(t) will give poro-elasticity related part of the signals in the time domain. One can evaluate the derivative of the spectrum based on the following fact. If F(ω) is the Fourier spectrum of \tilde{F}(t), where t is time, then one can determine

$$\frac{d F ( ω )}{d ω}$$

as the spectrum of −jt\tilde{F}(t).

Based on the above-described, embodiments of the invention provide methods that use filtering procedures to enhance the poro-elastic information in the seismic or acoustic data. The filtering procedures are as follows. First, for an evenly time sampled discrete signal \tilde{F}ᵢ, one calculates \tilde{D}ᵢ=−ji\tilde{F}ᵢ, where i is the time index and N is the number of samples. Then, for any frequency

$${ω}_{k} = \frac{2 π k}{N} ,$$

wherein k=0, . . . , N−1, one calculates Gₖ=G(ωₖ) by numerical integration of z-transforms of Dᵢ over the clockwise circular path in the complex plane centered at the coordinate origin and starting/finishing in ωₖ (see FIG. 5).

Referring to FIG. 5, to perform the integration, one may split the complex plane into L sectors (where L is preferably a big number, on the order of the number of time samples N) and define the angles of the sections as

$${α}_{t} = 2 π ( 1 - \frac{l}{L} ) .$$

For each pair of indices k,l, one defines frequency

$${ω}_{k , l} = \frac{2 π k}{N} exp ( {jα}_{l} )$$

(note ω_{k,l}=ωₖ l=0,L). For each l, one defines D_{k,l} as the z-transform of Dᵢ with z=exp(jω_{k,l}). Then, for any given fixed k, one determines Gₖ as a numerical integral of the function D_{k,l}, the arguments of which are ω_{k,l}, l=0, . . . L. Note that one may use a different numerical formula for Gₖ. For example, using a trapezoidal formula, one will get

$${G}_{k} = \frac{1}{2} {\sum }_{l = 0}^{L - 1} \frac{{D}_{k , l + 1} + {D}_{k , l}}{2} ( {ω}_{k , l + 1} - {ω}_{k , l} ) .$$

Applying an inverse discrete Fourier transform to Gₖ, one will obtain \tilde{G}ᵢ, which will be the estimation of poro-elasticity related part of \tilde{F}ᵢ. The linear signal transform \tilde{F}(t)→\tilde{G}(t) or \tilde{F}ᵢ→\tilde{G}ᵢ, described above, is a “Square Root Filter.”

The “Square Root Filters” as described above may be implemented as a filtering transformation in software. Application of this filter to seismic and/or acoustic data enhances part of the signal related to the poro-elasticity and can be used as is for such enhancement. The “Square Root Filter” can also be used on pre-stack seismic data. Results of filtering can later be stacked into new CDP and AVO gathers to be used for permeability and fracture density evaluation.

In addition, square root filtering may be applied to seismic and/or acoustic data before performing operations on them as described above (see steps 12 and 13 in FIG. 1). The results of filtering will have enhanced influence of poro-elasticity. Instant amplitudes and frequencies of the “Square Root Filtered” data together with body of low-frequency seismic attributes calculated from the initial data (or from the “Square Root Filtered” data) will provide new body of seismic attributes to be used for permeability and fracture density evaluation.

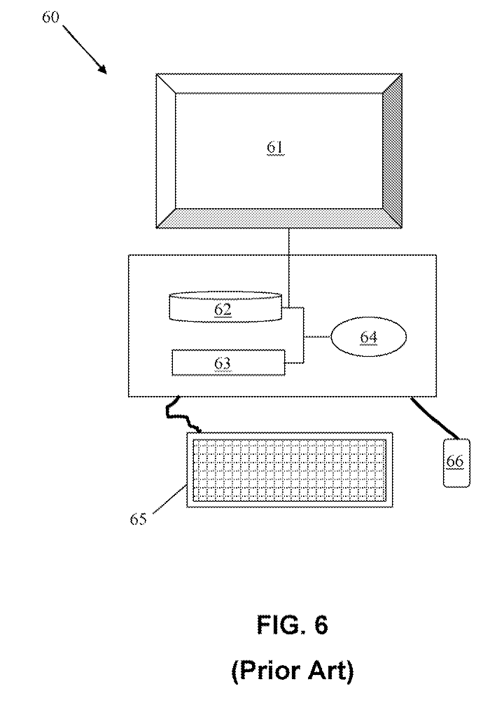

Some embodiments of the invention relate to systems that implement the methods of the invention. Such systems may be implemented, on any computing device, such as a personal computer as shown in FIG. 6. A personal computer 60, as shown in FIG. 6, may include a display 61, a processor 64, a storage device (such as a hard drive) 62, a memory 63, one or more input devices (such as a key board 65 and a mouse 66). In addition, some embodiments of the invention may relate to a computer readable media that stores a program having instructions to cause a processor to execute steps for implementing one or more methods of the invention. Such computer readable devices, for example, may include a hard drive, a floppy disk, a CD, a DVD, a tape, etc.

Advantages of the invention may include one or more of the following. Methods of the invention may be used for the determination of fluid mobility and fractures between wells, which is an extremely important application in oil and gas industry and in all industries related subsurface earth modeling. Embodiments of the invention may enhance the usage of seismic data which has broad coverage and gives an enormous benefit. In the long run, broad field studies using embodiments of the invention, in comparison with laboratory experiments, might help to establish proper set of poro-elastic models to use in acoustic and seismic 3D inversion. This kind of inversion will maximize usage of acoustic and seismic data when pores are present. “Square Root Filter” gives a possibility to enhance effects of fluid mobility in the seismic and acoustic data. It enhances and benefits the low-frequency seismic attribute calculations described above. It can also be used by itself to discover the areas with significant fluid mobility influence.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for identifying a nature of formation contrasts that cause changes in seismic or sonic wave properties in a low-frequency range, comprising:
obtaining a selected property of a formation surrounding a borehole, wherein the selected property is at least one selected from the group consisting of a permeability and a fracture density;
decomposing seismic signals into a set of instant amplitudes and frequency fields;
calculating a plurality of low-frequency attributes characterizing the low-frequency range of the seismic signals; and
establishing a correlation between at least one of the plurality of the low-frequency attributes and the selected property of the formation.

2. The method of claim 1, wherein the permeability is derived from well logs, well test data, or core data.

3. The method of claim 1, wherein the fracture density is derived from resistivity data.

4. The method of claim 1, wherein the seismic signals comprise Stoneley waves.

5. The method of claim 4, wherein the Stoneley waves include azimuthal changes.

6. The method of claim 4, wherein the selected property is permeability derived from attenuation and slowness of the Stoneley waves.

7. The method of claim 6, wherein the permeability is derived from the attenuation and slowness of the Stoneley waves by fitting experimental observation and theoretical values as determined by Biot-Barenblatt's model.

8. The method of claim 1, wherein the seismic signals comprise seismic CDP and/or AVO gathers.

9. The method of claim 1, wherein the seismic signals are processed with a square root filter to enhance poro-elasticity effects.

10. The method of claim 1, wherein the decomposing the seismic signals into the set of instant amplitudes and frequency fields comprises:
applying a sequence of narrow-pass filters to the seismic signals; and
calculating the instant amplitudes and frequency fields.

11. The method of claim 10, wherein the calculating the instant amplitudes and frequency fields is performed using Hilbert transform.

12. A method of claim 10, wherein the plurality of the low-frequency attributes is calculated as follows:
performing principal component analysis for the set of instant amplitudes and frequency fields;
discarding the principal component with the greatest eigenvalue;
other principal components with prevalent frequencies lower than the prevalent frequency of the greatest eigenvalue component are defined as low-frequency anomalies;
selecting a contiguous area with low values of the low-frequency anomalies and/or low values of the selected property of the formation as a reference area; and
determining values of d_{xqrt}, τ, d_{τ}, respectively, as an average value of \sqrt{f} ∂|R(f)|/∂f in the low frequency range, an average tangent of the value ln(∂|R(f)|/∂f) with regard to f, and an average value of f^{-τ} ∂|R(f)|/∂f in the low frequency range, wherein f is a frequency, R(f)=S(f)/ S̅₀(f), S(f) is the spectrum of seismic signals in a window around each point of the field, S̅₀(f) is the overall spectrum of the seismic signals in the reference area.

13. The method of claim 12, wherein the determining the values of d_{sqrt}, τ, d_{τ} is performed without reference to the reference area.

14. A method of claim 1, wherein the plurality of the low-frequency attributes is calculated as follows:
spectra fitting the seismic signals, in a sliding window along the trace of the seismic signals, to model spectra represented as a series of square root of frequency,
$$W ( f ) {\sum }_{i = 0}^{K} {{a}_{i} ( \sqrt{f} )}^{i} ,$$
where K is an integer and 1≦K≦5; and
determining the plurality of low-frequency attributes as absolute values of ratios of
$$\vert \frac{{a}_{i}}{{a}_{0}} \vert ,$$
1≦i≦K.

15. The method of claim 1, wherein the establishing the correlation between at least one of the plurality of low-frequency attributes and the selected properly of the formation is performed by: calculating correlation coefficients between the at least one of the plurality of low-frequency attributes and the selected property of the formation; and picking pairs with the best correlation.

16. The method of claim 15, wherein the picking the best correlation is by regression analysis.

17. The method of claim 1, further comprising estimating permeability or fracture density values by propagating the correlation established in the borehole into a 3D space surrounding the borehole.

18. The method of claim 17, wherein the propagating uses geo-statistical multivariate distribution of the permeability or fracture density values based on best correlated low-frequency attributes characterizing low-frequency range of the seismic signals or their combination.

19. A system comprising a processor and a memory, wherein the memory stores a program having instructions for causing the processor to perform a method for identifying a nature of formation contrasts that cause changes in seismic or sonic wave properties in a low-frequency range, the method comprising:
obtaining a selected property of a formation surrounding a borehole, wherein the selected property is at least one selected from the group consisting of a permeability and a fracture density;
decomposing seismic signals into a set of instant amplitudes and frequency fields;
calculating a plurality of low-frequency attributes characterizing the low-frequency range of the seismic signals; and
establishing a correlation between at least one of the plurality of the low-frequency attributes and the selected property of the formation.

20. The system of claim 19, wherein the plurality of the low-frequency attributes is calculated as follows:
performing principal component analysis for the set of instant amplitudes and frequency fields;
discarding the principal component with the greatest eigenvalue;
other principal components with prevalent frequencies lower than the prevalent frequency of the greatest eigenvalue component are defined as low-frequency anomalies;
selecting a contiguous area with low values of the low-frequency anomalies and/or low values of the selected property of the formation as a reference area; and
determining values of d_{sqrt}, τ, d_{τ}, respectively, as an average value of \sqrt{f} ∂|R(f) |/∂f in the low frequency range, an average tangent of the value ln(∂|R(f)|/∂f) with regard to f, and an average value of f^{-τ} ∂|R(f)|/∂f in the low frequency range, wherein f is a frequency, R(f)=S(f)/ S̅₀(f), S(f) is the spectrum of seismic signals in a window around each point of the field, S̅₀(f) is the overall spectrum of the seismic signals in the reference area.

21. The system of claim 19, wherein the plurality of the low-frequency attributes is calculated as follows:
spectra fitting segments of the seismic signals, in a sliding window along the trace of the seismic signals, to model spectra represented as a series of square root of frequency,
$$W ( f ) {\sum }_{i = 0}^{K} {{a}_{i} ( \sqrt{f} )}^{i} ,$$
where K is an integer and 1≦K≦5; and
determining the plurality of low-frequency attributes as absolute values of ratios of
$$\vert \frac{{a}_{i}}{{a}_{0}} \vert ,$$
1≦i≦K.

22. A computer readable medium storing a program having instructions for causing a processor to perform a method for identifying a nature of formation contrasts that cause changes in seismic or sonic wave properties in a low-frequency range, the method comprising:
obtaining a selected property of a formation surrounding a borehole, wherein the selected property is at least one selected from the group consisting of a permeability and a fracture density;
decomposing seismic signals into a set of instant amplitudes and frequency fields;
calculating a plurality of low-frequency attributes characterizing the low-frequency range of the seismic signals; and
establishing a correlation between at least one of the plurality of the Sow-frequency attributes and the selected property of the formation.

23. The computer readable medium of claim 22, wherein the plurality of the low frequency attributes is calculated as follows:
performing principal component analysis for the set of instant amplitudes and frequency fields;
discarding the principal component with the greatest eigenvalue;
other principal components with prevalent frequencies lower than the prevalent frequency of the greatest eigenvalue component are defined as low-frequency anomalies;
selecting a contiguous area with low values of the low-frequency anomalies and/or low values of the selected property of the formation as a reference area; and
determining values of d_{sqrt}, τ, d_{τ}, respectively, as an average value of \sqrt{f} ∂|R(f)|/∂f in the low frequency range, an average tangent of the value ln(∂|R(f)|/∂f) with regard to f, and an average value of f^{-τ} ∂|R(f)|/∂f in the low frequency range, wherein f is a frequency, R(f)=S(f)/ S̅₀(f), S(f) is the spectrum of seismic signals in a window around each point of the field, S̅₀(f) is the overall spectrum of the seismic signals in the reference area

24. The computer readable medium of claim 22, wherein the plurality of the low frequency attributes is calculated as follows:
spectra fitting segments of the seismic signals, in a sliding window along the trace of the seismic signals, to model spectra represented as a series of square root of frequency,
$$W ( f ) {\sum }_{i = 0}^{K} {{a}_{i} ( \sqrt{f} )}^{i} ,$$
where K is an integer and 1≦K≦5; and
determining the plurality of low-frequency attributes as absolute values of ratios of
$$\vert \frac{{a}_{i}}{{a}_{0}} \vert ,$$
1≦i≦K.

25. A method for enhancing poro-elastic effects in a seismic signal spectrum, F(ω), comprising:
finding a derivative of the seismic signal spectrum, dF(ω)/dω; and
performing an estimation of an integral of a function of dF(ω)/dω in a clockwise circular path in a complex plane centered at the coordinate origin, wherein the integration is performed starting and finishing at the same frequency, ω.
